(19) United States
(12) Patent Application Publication
(10) Pub. No.: US 2002/0188736 A1
(43) Pub. Date: Dec. 12, 2002

(54) System and method for controlling terminal application usage through subscriber-application association

(75) Inventor: Hannu Jarvensivu, Nokia (FI)

Correspondence Address: Steven R. Funk, Crawford PLLC, 1270 Nothland Drive, Suite390, St. Paul, MN, 55120, US

(73) Assignee: Nokia Corporation, Espoo (FI)

(21) Appl. No.: 09/878,629

(22) Filed: Jun. 11, 2001

(51) Int. Cl. G06F 15/16

(52) U.S. Cl. 709/229; 709/217

(57) ABSTRACT

A system and method for authorizing operation of an application on a terminal in a network. An application is initiated on the terminal by a requesting user. A user data segment locally available at the terminal includes data that is unique to the requesting user, and is searched for an application identifier corresponding to the application initiated by the user. If the application identifier is found not to be associated with the local user data segment, a remotely stored user data segment available on the network is searched to determine if it includes the application identifier. If the application identifier is located in the remotely stored user data segment, the local user data segment on the terminal is updated with the application identifier, and execution of the application is enabled for use by the requesting user. Otherwise, execution of the application is prohibited until the user complies with access rules, such as providing payment for permission to execute the application.

### FIELD OF THE INVENTION

The present invention relates generally to network communications systems, and more particularly, to a system and method for facilitating charging of application usage on terminals, regardless of the manner in which the application was availed to the terminal.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. The proliferation of local, regional, and global networks such as the Internet has availed a sea of information to an information hungry society. These networking technologies have expanded to increasingly include wireless and mobile technologies. Through these networks, information can be downloaded to desktop systems, wireless systems, mobile systems, etc. For example, information available via the Internet can now be downloaded onto mobile wireless units, such as cellular telephones, personal digital assistants (PDAs), laptop computers, etc. One such technology facilitating the transfer of Internet content to and from wireless devices is the Wireless Application Protocol (WAP), which integrates the Internet and other networks with wireless network platforms. Generally, WAP is a set of protocols that accounts for characteristics and functionality of both Internet standards and standards for wireless services. It is independent of wireless network standards, and is designed as an open standard. WAP bridges the gap between the wireline Internet paradigm and the wireless domain, to allow wireless device users to enjoy the benefits of the Internet across both platforms.

One particular type of information that can be downloaded via these wireline and wireless networks includes software, such as application software, control software, etc. that is operable on the receiving device. Often times, such software is made available for purchase by an online vendor, or is otherwise provided in connection with another service. This type of software or program(s) is thus not intended to be freely available for transfer between users, but rather is intended to be a controlled transfer of content with limitations on further transfers or duplications. However, as described more fully below, other communications technologies may allow users to bypass such controlled content transfers, thereby frustrating the purpose and aspirations of online businesses.

Second generation wireless service, often referred to as 2G wireless service, is a current wireless service based on circuit-switched technology. 2G systems, such as Global System for Mobile communications (GSM) and Personal Communications Services (PCS), use digital radio technology for improved quality and a broader range of services over first generation mobile technologies. 3G, or third generation, refers to a set of digital technologies that promises improvements in capacity, speed and efficiency by deploying new packet-based transmission methodologies between terminals and the network. Users of 3G devices and networks will have access to multimedia services such as video-on-demand, video conferencing, fast web access and file transfer. Data transmission speed is one key improvement 3G has over its predecessors.

While the unauthorized transfer (i.e., downloading) of information can be effected in 2G network technologies, the terminals operable in connection with 2G networking technologies do not have an execution environment that will be a part of the 3G system terminal environment. An “execution environment” is a software environment in which applications are executed. The aim of a mobile execution environment is to provide a comprehensive and standardized environment on mobile phones for executing operator or service provider specific applications. A mobile execution environment designed on a mobile terminal could build a Java virtual machine into the client mobile phone. As is known in the art, Java is a “write once, run anywhere” programming language that facilitates such a execution environment. In such an environment, 3G devices may be provided with sophisticated intelligent customer menus, mobile phone location services, voice recognition, icons, softkeys, games, and the like.

Not only do 2G networks have no real execution environment, 2G services are generally controlled by the network operator. The execution environment available in 3G networks and terminals will enable certain protocol devices, such as Wireless Application Protocol (WAP) devices, to offer a wider range of service features. These devices, likely be based on Java technology, will soon be widely available. While such Java-enabled terminals will avail users to a variety of new services to mobile subscribers, the real execution environment poses a significant risk for network operators and service providers. More particularly, the uncontrolled delivery and application use may threaten significant revenue losses to operators/service providers, as well as present new security risks.

For example, a variety of known technologies allow a terminal user to gain access to an application that is only intended to be accessed via downloading from the service provider and/or operator. This access may be gained through direct download from external equipment, or transmission from one terminal to another via technologies such as Infrared Data Access (IrDA), Bluetooth, Multimedia Messaging Service (MMS), etc. These and other technologies may allow transfers from terminal to terminal, thereby bypassing the intended download access from the service provider and/or network operator. Further, direct transfer from an external source, such as via IrDA or serial cable, may also allow terminal users to bypass the intended download access.

Due to the existence of Subscriber Identity Module (SIM) technology, a user may be able to take a portable SIM, smart card, or other analogous portable access component, and use it in any terminal capable of receiving such an identification component. It is therefore important to be able to identify whether or not the actual user of the mobile terminal has authorization to use the application. In other words, users could bypass having to pay for access and/or use of an application where a terminal was used by a first user for the application, and a second user buys or otherwise uses that same terminal.

Therefore, the challenge still remains to minimize unauthorized application usage at terminals. There is a need in the communications industry for a system and method for controlling application use that a user may have obtained through methods not under the control or scrutiny of the network operator and/or service provider. There is a further need to provide network operators and service the ability to charge for application use, even if the particular user obtained the application in an unauthorized or otherwise unconventional manner. The present invention provides a solution to these and other shortcomings of the prior art, and offers additional advantages over the prior art.

### SUMMARY OF THE INVENTION

The present invention is directed to a system and method for facilitating charging of application usage on terminals, regardless of the manner in which the application was loaded onto the terminal.

In accordance with one embodiment of the present invention, a method is provided for authorizing operation of an application on a terminal in a network. The application is initiated on the terminal by a requesting user. A user data segment locally available at the terminal includes data that is unique to the requesting user. This local user data segment is searched for an application identifier corresponding to the application initiated by the user. If the application identifier is not found to be associated with the local user data segment, a remotely stored user data segment that is available on the network is searched to determine if it includes the application identifier. Where the application identifier is located in the remotely stored user data segment, the local user data segment on the terminal is updated with the application identifier, and execution of the application is enabled for use by the requesting user.

More particular embodiments of this aspect of the invention include prohibiting execution of the application by the requesting user where the application identifier is not located in either the local or remotely stored user data segment. Where the requesting user is prohibited from executing the application in this manner, the user may be presented with an option to acquire the application, and payment may be received to lift the prohibition. In response to accepting the user's payment, the remote and local user data segments are updated to include the application identifier, and execution of the application by the requesting user is enabled.

In accordance with another embodiment of the invention, a system is provided for allowing a network service provider to control use of an application. The application to be controlled has an associated application identifier. The system includes a transferable user data module, which includes local user profile information unique to a user requesting access to the application. A profile directory is maintained on a network, where the profile directory includes remote user profile information for at least one user. A user terminal is loaded with the application, where the user terminal is coupled to the transferable user data module in order to access the local user profile information. A compare module is coupled to receive the application identifier to determine whether the application identifier matches any authorized application identifiers already associated with the local user profile information. An application execution module permits user execution of the application if the application identifier matches one of the authorized application identifiers associated with the local user profile information. The application execution module further requests permission from the service provider to execute the application by searching the remote user profile information for the application identifier, if the application identifier fails to match one of the authorized application identifiers associated with the local user profile information.

In accordance with another embodiment of the invention, a method is provided for enabling operation of an application on a terminal in a network. The method includes linking an application identifier with user profile information unique to each user authorized to execute the application, and determining whether the application identifier has been linked with the user profile information of a requesting user attempting to execute the application from the terminal. Execution of the application is denied to the requesting user if the application identifier has not been linked with the user profile information, and is permitted to the requesting user if the application identifier has been linked with the user profile information. In more particular embodiments, linking an application identifier with user profile information includes storing the application identifier in a network profile directory segment remote to the terminal, or in a portable access module such as a Subscriber Identity Module (SIM).

The above summary of the present invention is not intended to describe each illustrated embodiment or implementation of the present invention. This is the purpose of the figures and the associated discussion which follows.

### BRIEF DESCRIPTION OF THE DRAWINGS

FIG. 1 is a system block diagram illustrating an exemplary environment in which the principles of the present invention may be applied;

FIG. 2 is a flow diagram illustrating an exemplary method of controlling application usage in accordance with the principles of the present invention;

FIG. 3 is a flow diagram illustrating another embodiment of an application usage control methodology in accordance with the present invention;

FIG. 4 is a flow diagram illustrating another embodiment of an application usage control methodology in accordance with the present invention, where a network connection is effected in the application startup phase;

FIG. 5 is a flow diagram of another embodiment of an application usage control methodology in accordance with the present invention, where local and remote activities are distinguished;

FIG. 6 is an exemplary embodiment of a manner of associating an application to a particular user during a download procedure;

FIG. 7 is an exemplary embodiment of a manner of associating an application to a particular user upon the user's first execution attempt of the application; and

FIG. 8 is a block diagram of one illustrative embodiment of a system for facilitating the charging of application usage in accordance with the present invention.

### DETAILED DESCRIPTION OF THE EMBODIMENTS

In the following description of the various embodiments, reference is made to the accompanying drawings which form a part hereof, and in which is shown by way of illustration various embodiments in which the invention may be practiced. It is to be understood that other embodiments may be utilized, and structural and functional modifications may be made without departing from the scope of the present invention.

The present invention is directed to a system and method for controlling application usage by a terminal user. An application is associated with a particular user, such that the application is allowed to be executed only by that particular user, thereby disallowing an unauthorized terminal user from executing the application even though the unauthorized terminal user may have loaded the application onto the user's terminal via unauthorized means. In this manner, only authorized users will be allowed to execute a program or application, regardless of how the program or application was transferred to the user's terminal. This usage control facilitates the charging of applications in a manner desired by the network operator or service provider, notwithstanding unauthorized application distribution.

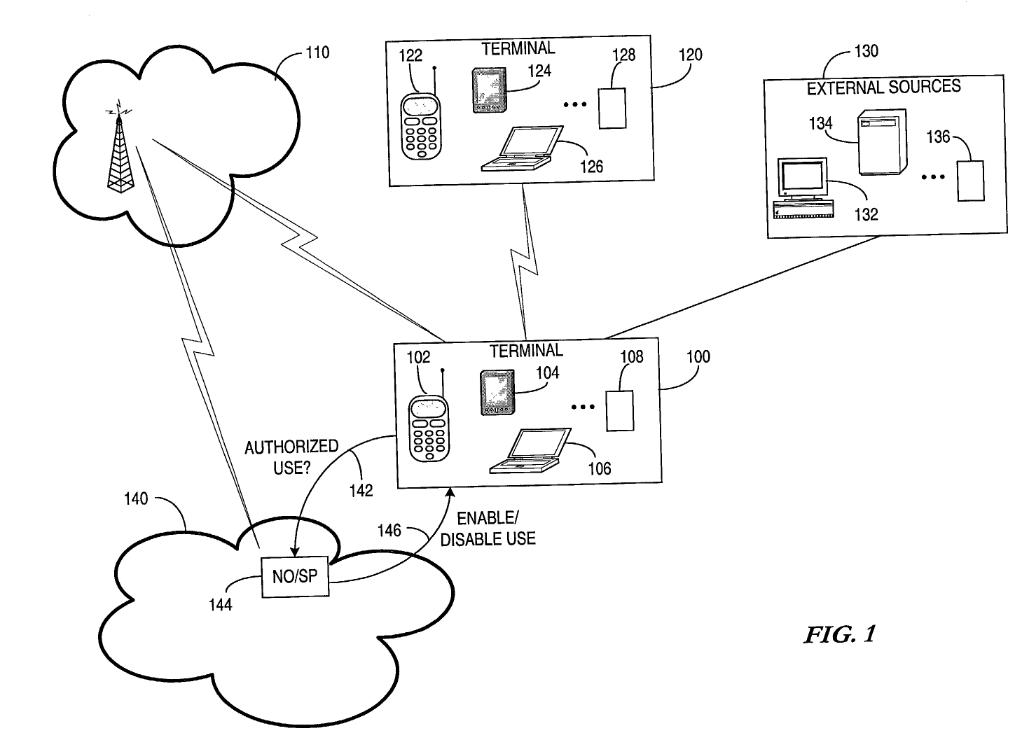

FIG. 1 is a system block diagram illustrating an exemplary environment in which the principles of the present invention may be applied. FIG. 1 illustrates a variety of manners in which a terminal 100 can gain access to a particular application. For purposes of illustration, the terminal 100 is represented as a wireless terminal, such as a cellular telephone 102, a personal digital assistant (PDA) 104, a notebook or laptop computer 106, or any other type of terminal represented by device 108.

A variety of technologies exist which may allow the user of terminal 100 to download or otherwise receive a particular application without following the appropriate procedure of the application supplier (e.g., network operator and/or service provider). The appropriate procedure provided by the application supplier may be that a user must download the application in one of a variety of manners, where the network operator or service provider authorizes the downloading of the application to the user. An example is where the user has purchased the application, thereby authorizing the user to download the application to the terminal 100, such as represented by the download (wireless or otherwise) from service provider 144 through radio network 110 to the terminal 100.

As indicated above, there are several methods in which applications may be delivered to the user equipment, i.e. terminal 100, while bypassing the requisite download from the network operator/service provider application server. A first example includes a terminal-to-terminal transfer of the application, illustrated in FIG. 1 as a transfer of the application from terminal 120 to terminal 100. As was described in connection with terminal 100, the terminal 120 may include a variety of different devices, including a cellular telephone 122, a PDA 124, a notebook or laptop computer 126, or any other type of terminal represented by device 128. Various technologies allow such a controlled terminal-to-terminal transfer, including Infrared Data Access (IrDA), Bluetooth, Multimedia Messaging Service (MMS), other close-range transmission technologies, etc. For example, a user of terminal 120 may transmit the application to terminal 100 via Bluetooth technology, thereby bypassing the otherwise requisite download of the application from the network operator/service provider.

Another example in which application may be provided to terminal 100 is via an external source-to-terminal transfer. This is represented in FIG. 1 as a transfer from an external source 130 to the terminal 100. The external source may include any type of external source, including a personal computing device 132, a mid-frame or main-frame computing system 134, or any other type of external source represented by device 136.

As can be seen from the foregoing examples, a variety of manners of transferring the application to the terminal 100 may be used. This type of application transfer, where downloading of the application from the network operator/service provider is bypassed, can result in a loss of revenue to the operator/service provider, as well as adversely affecting network security.

The present invention allows the network operator/service provider to control the use of applications supplied by the network operator/service provider, regardless of how the user of terminal 100 came into possession of the application. In this manner, it is determined whether the terminal 100 is authorized to use the application, as represented in this example by the query line 142 from terminal 100 to the network 140. It should be recognized that the network 140 may be distinct, integrated with, or the same as other networks coupled to the terminal 100 such as the network 110. In the example of FIG. 1, the query is analyzed by the network operator/service provider (NO/SP) 144, which in response provides an indication, represented by line 146, of whether or not the application is enabled for use. In this manner, control of the usage of the application on terminal 100 may be allowed or restricted, not necessarily based on the manner in which the application made its way to terminal 100, but instead based on additional associations linking authorized users to the application. Further, by controlling the use of the application, the NO/SP 144 may charge for application usage in accordance with a predetermined charging arrangement, such as charging for the time an application is used, charging for each use of the application, requiring a one-time charge for the application, etc.

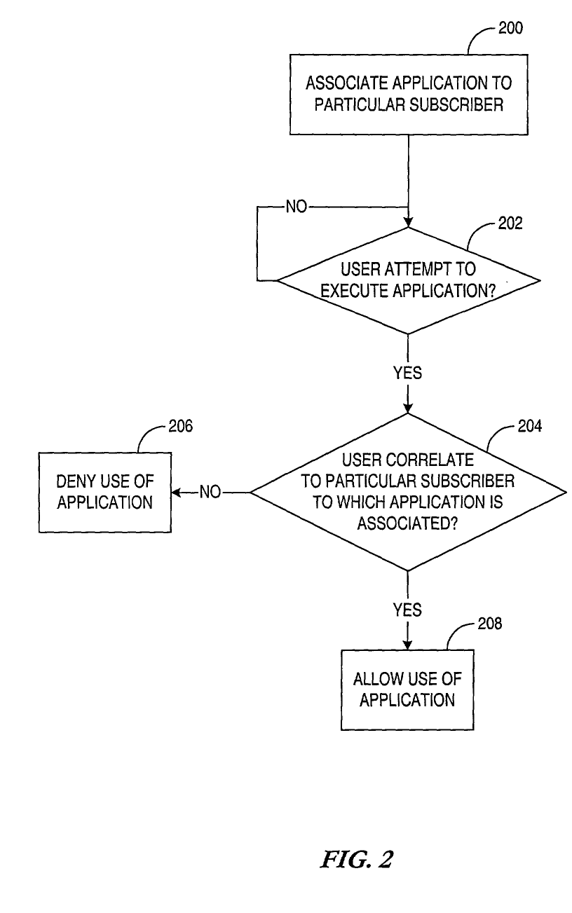

FIG. 2 is a flow diagram illustrating an exemplary method of controlling application usage in accordance with the principles of the present invention. As FIG. 2 illustrates, the present invention allows the operator to charge based on application use, even where the user obtained the application in unauthorized manners. This can be accomplished by associating 200 the application to a particular subscriber in the network. For example, application identifications may be attached to a user profile, as described more fully below. When the user attempts to execute the application as determined at decision block 202, it is determined 204 whether the user attempting to execute the application can be correlated to a particular subscriber to which the application is associated. If not, the user will be denied 206 use of the application, such that the user will be unable to execute the application on the terminal. Otherwise, if it is determined 204 that the user attempting to execute the application correlates to a subscriber to which the application is associated, the user is allowed to execute the application as shown at block 208.

The present invention therefore provides an additional point of control for the network operator/service provider, by controlling the application usage in addition to, or in lieu of, controlling the application download. In a more particular embodiment of the invention, the control mechanism focuses on the first execution attempt of the application. This will be described more fully below.

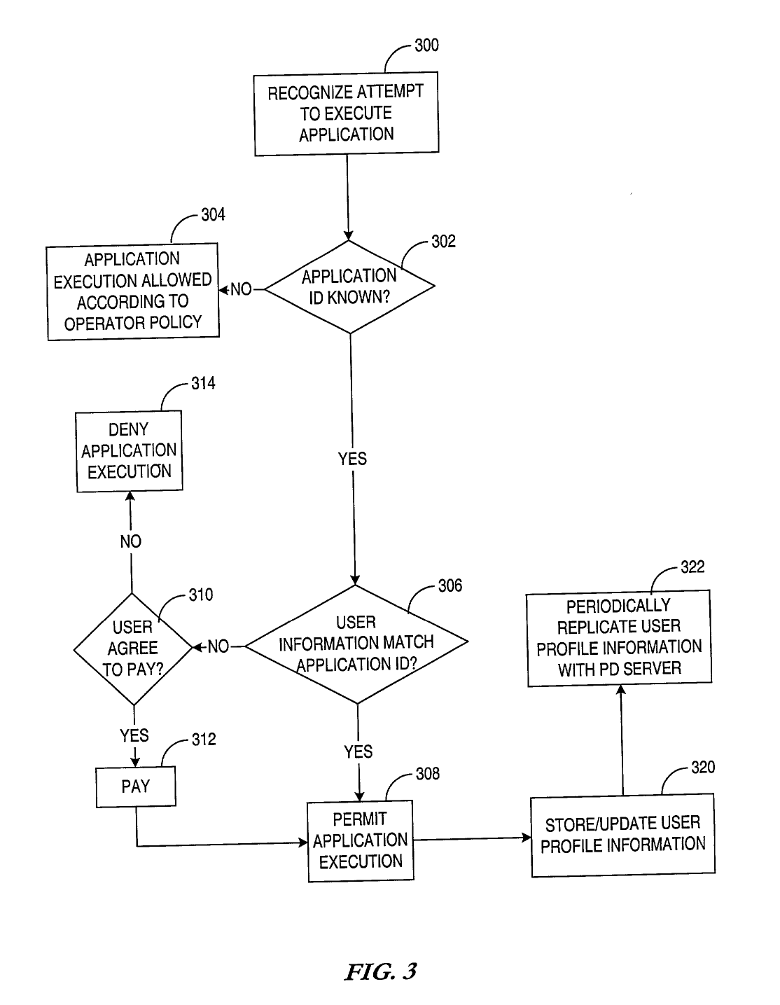

FIG. 3 is a flow diagram illustrating another embodiment of an application usage control methodology in accordance with the present invention. In the illustrated embodiment, an attempt to execute an application is recognized 300. For example, when a user attempts to execute an application, this attempt is recognized at the user terminal to prompt further action in accordance with the invention. This further action may involve one or both of locally (i.e., at the terminal) ascertaining whether the user is authorized to execute the application, or remotely (i.e., through communicated requests for authorization to a remote system, such as a server controlled by the network operator/service provider).

The application in which the user is attempting to execute has an associated application identification (ID). It is determined 302 whether the application ID is recognized or otherwise known. This determination of the application ID may be performed locally followed by a remote check. For example, a local check to determine whether the application ID is valid may be performed, but a remote check may follow up the local check if the local check failed to establish that the application ID was valid. If the application ID is unknown, execution of the application is allowed according to operator policy as shown at block 304. For example, the operator policy may be to deny execution of the application.

If the application ID is recognized as determined at decision block 302, it is determined 306 whether the user profile information includes information indicating that the user is authorized to execute the application. In a more particular embodiment, at least a portion of the stored user profile information may be compared to the application ID, to determine whether there is a match of the application ID to that portion of the user profile information. If there is a match, this indicates that the user is authorized to execute the application, and therefore the user is permitted 308 to execute the application. Otherwise, the user may be asked to pay to execute the application, where “pay” broadly indicates that the user has agreed to at least some term(s) in order to execute the application. One example would be that the user has agreed to pay a sum of money to use the program/application, although the “payment” need not be monetary. If the user agrees to pay as determined at decision block 310, the user then makes the payment as shown at block 312, and the user is permitted 308 to use the application. Otherwise, if the user fails to make the requisite “payment,” then execution of the application is denied, as shown at block 314.

The user profile information is stored 320 at the terminal, so that local checks can be performed upon a subsequent attempt to execute the application. Further, occasional replications of the user profile information stored at the terminal and the user profile information stored in the profile directory (e.g., at the server controlled by the network operator/service provider) are carried out, as shown at block 322. For example, this occasional replication may be performed periodically, or upon recognition of a predefined event.

There are various reasons to replicate or otherwise synchronize the user profile information and the corresponding information in the profile directory. For example, the network operator or service provider may provide all subscribers free access to a certain application(s) for some predetermined period of time, where the expiration of that time requires payment by those subscribers wanting continued access to the application. In such a case, the recognition of the end of such a “trial period” may remove the application identifier from the profile directory, which can then be updated on the terminal (e.g., SIM database) when these information segments are synchronized. In such a case, the user may still have the application locally stored on the terminal, but the application identifier will have been removed from the locally stored user profile information when it has been synchronized with the updated network profile directory. Therefore, the user is no longer “authorized,” thereby requiring the user to agree to payment upon the first attempted execution of the application following expiration of the trial period.

Another example for why such replication is beneficial is where an authorized subscriber has lost or destroyed the terminal, including the locally stored user profile information such as that stored in a SIM database. In such a case, all personal information stored in the SIM database (for example) is lost, but the user may want to recreate a similar application set to a replacement terminal. Occasional replications of the profile directory and the locally stored user profile information also keeps the network profile directory up to date so that such a recreation is possible. There are a variety of other reasons for replicating or otherwise synchronizing these information segments.

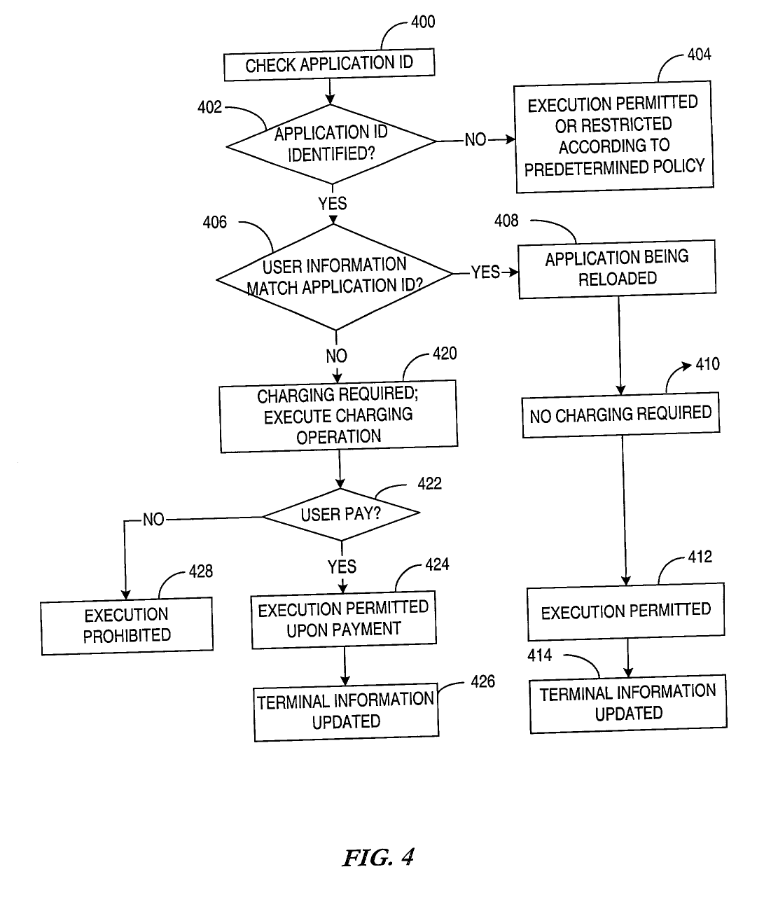

FIG. 4 is a flow diagram illustrating another embodiment of an application usage control methodology in accordance with the present invention, where a network connection is effected in the application startup phase. In this embodiment, the application ID is checked 400, and it is determined 402 whether the application ID is identified. In one embodiment of the invention, the application ID is checked at the network, such as at the server operated by the network operator/service provider. In such an embodiment, a check to the network is performed each time the terminal user initiates execution of the application, so that authorization is determined upon each use. This might be the case where the terminal is not equipped to receive a programmable identification module such as a SIM, but otherwise includes user profile information. Or, this may be the case for a terminal that may be used by multiple people, and certain user profile information is entered into the terminal to identify the user. The user profile information can then be transmitted to the network, and the network profile directory can be checked to determine whether that user (as defined by the user profile information) is authorized to execute the application on the terminal.

In another exemplary embodiment of the invention, checking the application ID 400 first involves checking a local user data segment, i.e., an internal check at the terminal itself. It is then determined 402 whether the local user data segment, such as a SIM database, includes an identification of an application ID associated with the application to be executed. Checking the application ID 400 further includes checking the application ID at the network, if the application ID was not identified at the local user data segment. It is then determined 402 whether the remote user data segment, such as the network profile directory controlled by the network operator/service provider, includes an identification of the application ID of the application to be executed. The illustrated embodiment of FIG. 4 contemplates various manners of checking the application ID 400 and identifying the application ID in different databases.

If the application ID is not identified, then application execution is permitted or restricted according to predetermined policy as shown at block 404, analogous to that described in connection with FIG. 3. If the application ID is known, it is determined 406 whether the user profile information matches the application ID. If so, this indicates that the user has already paid for the application, but is now, for whatever reason, reloading the application to the user's terminal as shown at block 408. In this case, no charging is required 410, and application execution is permitted 412. Further, the user profile information is updated 414 at the terminal, such as by updating a Subscriber Identity Module (SIM) database.

If the user information does not match the application ID as determined at decision block 406, then the operator may require that the user be charged to use the program/application, and a charging operation is executed 420. If the user opts to comply with the operator's charge request as determined at decision block 422, then application execution is permitted upon payment as shown at block 424, and the user profile information is updated 426 at the terminal (e.g., updating a SIM database). If the user does not pay 422, then application execution is prohibited 428.

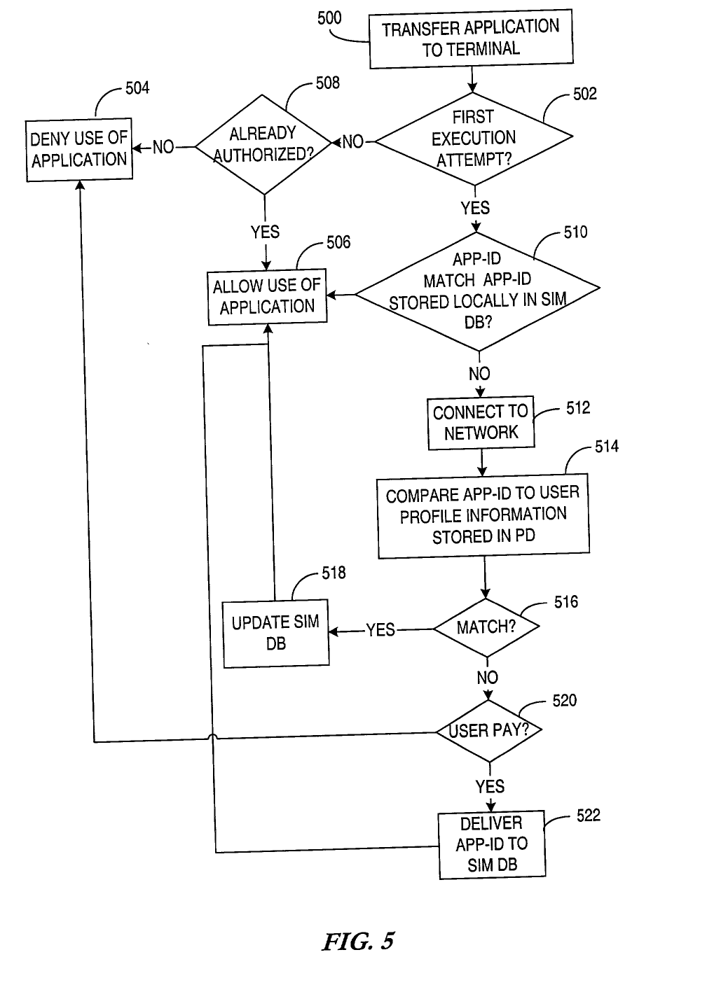

FIG. 5 is a flow diagram of another embodiment of an application usage control methodology in accordance with the present invention, where local and remote activities are distinguished. In this embodiment, the application is shown at block 500 to have been transferred to the terminal. This transfer can occur in any way, whether authorized or unauthorized by the network operator/service provider. For example, this transfer can be effected through the operator's intended download service, or may be effected through unauthorized means such as close-range transmission methods (e.g., Bluetooth, IrDA, MMS, etc.).

The embodiment illustrated in FIG. 5 contemplates initiating usage authorization in connection with the present invention upon the first execution attempt. If the application usage is not the first execution attempt as determined at decision operation 502, then the application use may be denied 504 or allowed 506 depending on whether the user is already authorized 508 to execute the application. In one embodiment of the invention, the first execution refers to the first attempt made by the user to execute or download the application, in which case the local user profile information (e.g., SIM database) will not include an authorizing application identifier for that application (described more fully below). In an exemplary embodiment, the “first execution” generally refers to the first execution attempt each time the application is selected for use at the terminal—e.g., each time the user opens the application for use at the terminal. The “first execution” attempt may also be defined in other ways as desired by the network operator/service provider, such as the first attempt each month (e.g., month-to-month payment required), etc.

If it is the first execution attempt 502, it is determined 510 whether the application ID matches an application ID locally stored in the terminal memory, such as a SIM database. If so, the user is allowed to use the application as shown at block 506. Otherwise, the terminal must establish a network connection 512, so that the application ID can be compared to the user profile information stored on the network, such as at a profile directory (PD) of a server, as shown at block 514. If a match is found 516, the SIM database is updated 518, and use of the application is allowed 506. Otherwise, if no match is found, the user may be required to make some payment to use the application, as shown at decision block 520. If the user does not agree to pay where required, use of the application is denied 504. If the user agrees to pay, the application ID is delivered 522 to the SIM database at the terminal, and the user is allowed to execute the application as shown at block 506.

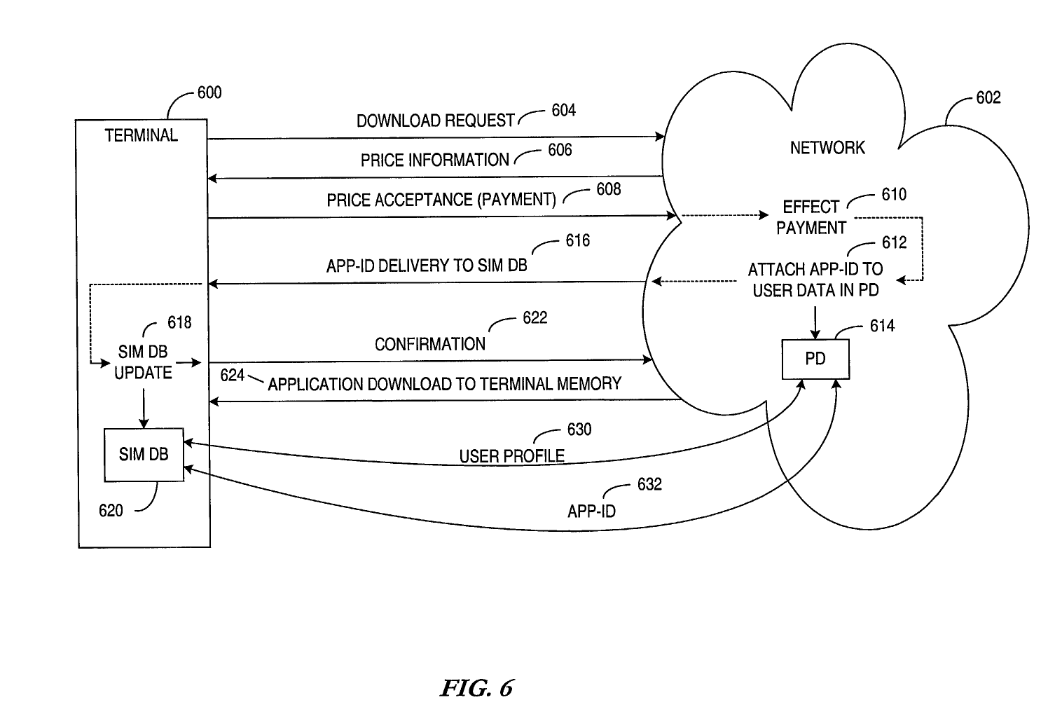

Referring now to FIG. 6, an example of a manner of associating an application to a particular user during a download procedure is provided. In this example, the user of the terminal 600 initiates a download of the desired application from a network 602, such as from a server controlled by the network operator/service provider. The download request 604 is made from the terminal 600 to the network 602. In response, price information 606 is provided to the terminal 600. If the user decides to comply with the terms (e.g., pay a requested amount of money), a price acceptance or payment 608 is communicated from the terminal 600 to the network 602. The payment is then effected 610. For example, a call data record (CDR) may be provided to the charging gateway (CG), or a prepaid account may be debited from for that particular user. It should be recognized that the particular time at which payment is made is not of great concern as it pertains to the present invention. For example, the CDR payment method may be carried out upon completion of downloading of the application.

Once payment has been effected, the application ID may be linked or “attached” 612 to the user data in the profile directory (PD). In this manner, the profile directory at the network is updated to reflect that user's authorization to execute the particular application, which is represented by the storing of the application ID in the profile directory (PD) 614. In order to reconcile the terminal SIM database with the network PD, the application ID is delivered to the SIM DB, as shown by communication segment 616.

It should be recognized that storing the application ID in the SIM DB provides for terminal-independent authorization for the particular user, since the SIM database information is unique to each user. A SIM database is one example of “portable” user profile information that provides for such terminal-independent authorization in connection with the present invention. In another embodiment, a memory in the terminal may be used to receive the application ID from the network PD upon authorization. For example, a portion of a terminal memory may be partitioned or otherwise allocated to store user profile information, and if/when that user no longer wants to use that particular terminal (e.g., a publicly-accessible terminal available to multiple users), the user could initiate a synchronization of the locally stored user profile information with the network profile directory. A subsequent terminal accessed by that user would again require the user to access the network to probe the profile directory for authorization to execute the application, and the local memory of that terminal could then be updated to reflect the current user profile information. This embodiment utilizes some manner of initially identifying the user at the newly accessed terminal, such as entry of identification information (e.g., telephone number, social security number, etc.) so that the network profile directory can be accessed to identify the user, and to ultimately determine whether that user is authorized to use the application. Therefore, as can be seen, various manners of updating the user profile information at the terminal being used by the user are contemplated in connection with the present invention.

Receipt of the application ID 616 at the terminal 600 prompts a SIM database update 618, which is represented by the storing of the application ID in the SIM database 620. When the SIM database is updated, the terminal 600 issues an update confirmation 622 back to the network. In response, the application is downloaded 624 to the terminal memory for use by the subscriber.

The user profile information 630 is duplicated in the PD 614 of the network 602 and the SIM database 620 of the terminal 600. Similarly, the application ID associated with the particular application is duplicated in both the PD 614 and SIM database 620, as represented by the APP-ID line 632. Duplicated user profiles 630, as well as unique application IDs 632 for all applications offered through the operator network, are thus used to control the charging of stand-alone applications that may not have been downloaded from the operator network. This also prevents spreading harmful applications, such as viruses, that may damage the terminal.

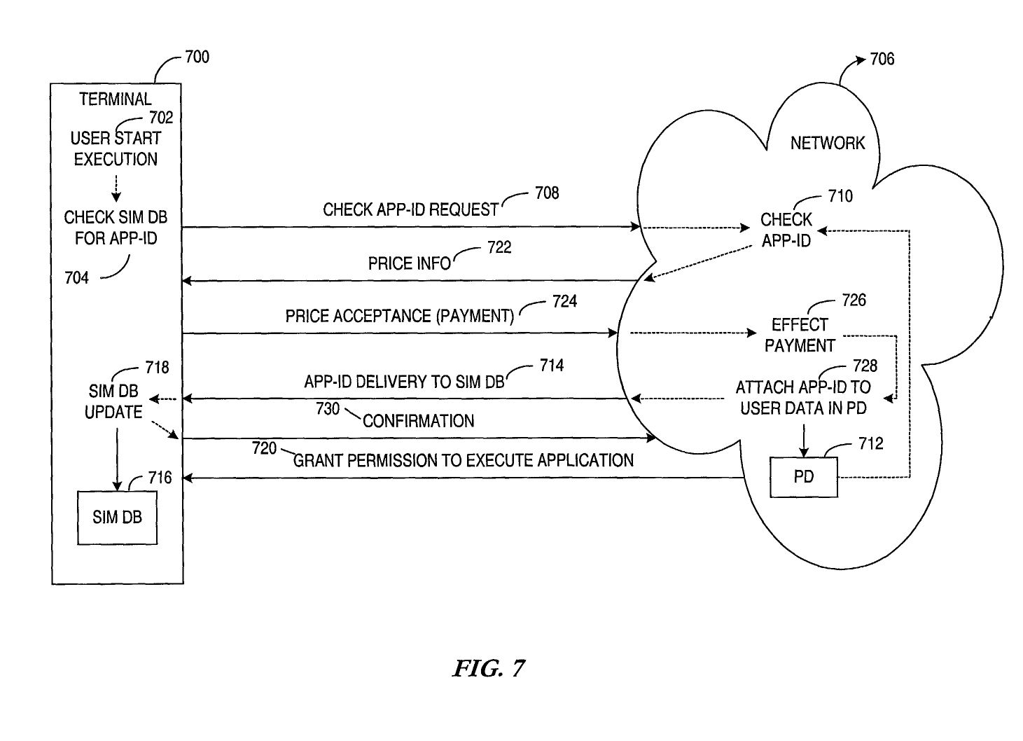

Referring now to FIG. 7, an example of a manner of associating an application to a particular user upon the user's first execution attempt of the application is provided. In this example, the user of the terminal 700 initiates execution of the application 702. At the terminal 700, the SIM database is checked 704 to determine whether the application ID associated with that application is currently associated with the user profile of the requesting user. If a match is found, the user is allowed to execute the application. Otherwise, a query to the network 706 is made to effect an application ID search request 708, which initiates a check 710 to determine whether the application ID is associated with the user profile information as stored in the PD 712 at the network 706. If the application ID check 710 results in a match of the application ID to the user information profile (i.e., indicating that the user is authorized to execute the application), then the application ID is delivered 714 to the SIM database 716 to effect a SIM database update 718, and the user is granted permission 720 to execute the application.

If the application ID check 710 does not result in a match of the application ID to the user information profile, then price information 722 for the application is provided to the terminal 700. If the user decides to comply with the terms (e.g., pay a requested amount of money), a price acceptance or payment 724 is communicated from the terminal 700 to the network 706. The payment is then effected 726. For example, a call data record (CDR) may be provided to the charging gateway (CG), or a prepaid account may be drawn from for that particular user. Again, the particular time at which payment is made is not of great import with respect to the present invention, as the CDR payment method may be carried out at any desired stage of the authorization procedure.

Once payment has been effected 726, the application ID may be attached or otherwise associated 728 to the user data in the profile directory (PD) 712. In this manner, the profile directory 712 at the network 706 is updated to reflect that user's authorization to execute the particular application, which is represented by the storing of the application ID in the profile directory (PD) 712. In order to reconcile the terminal SIM database 716 with the network PD 712, the application ID is delivered to the SIM DB (or other memory housing user profile information) as shown by communication segment 714.

Receipt of the application ID 714 at the terminal 700 prompts the SIM database update 718, which is represented by the storing of the application ID in the SIM database 716. When the SIM database 716 is updated, the terminal 700 issues an update confirmation 730 back to the network 706. In response, permission is granted 720 for the subscriber to execute the application at the terminal 700.

Again, the user profile information may be duplicated in the PD 712 of the network 706 and the SIM database 716 of the terminal 700. Similarly, the application ID associated with the particular application may be duplicated in both the PD 712 and SIM database 716. Duplicated user profiles, and unique application IDs for all applications offered through the operator network, are thus used to control the charging of stand-alone applications that may not have been downloaded from the operator network.

It should be recognized that while the foregoing examples make reference to a SIM database, any database or memory may analogously be used. For example, the information may be stored in any memory or database of terminals that do not have a SIM database per se.

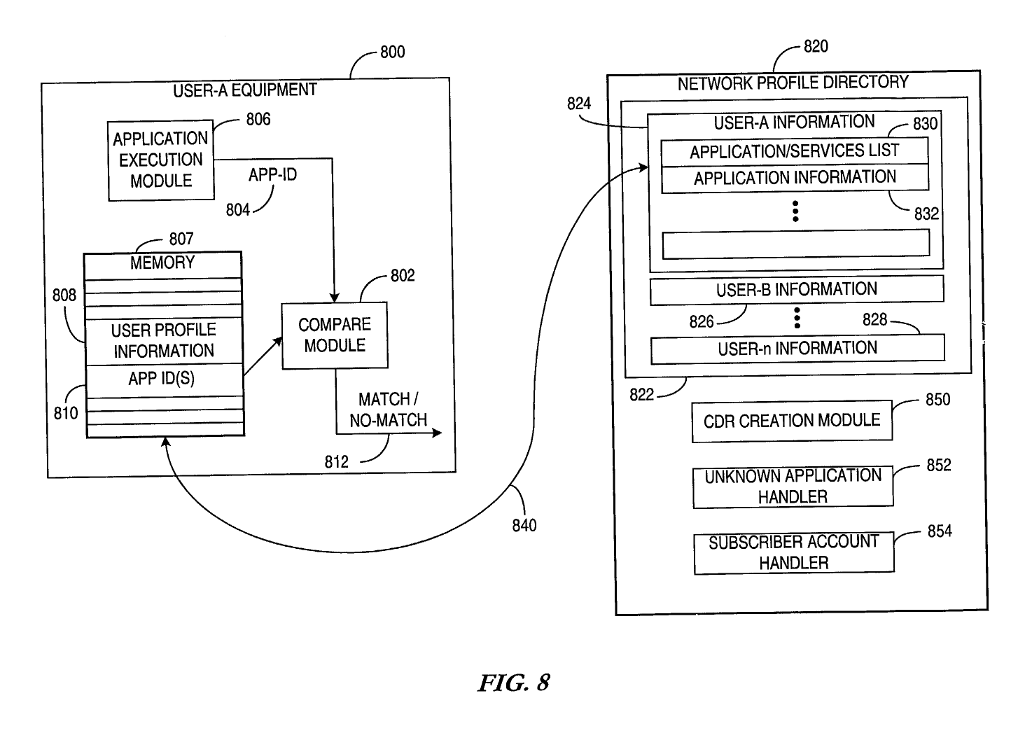

FIG. 8 is a block diagram of one illustrative embodiment of a system for facilitating the charging of application usage in accordance with the present invention. The user equipment (UE) 800 represents the UE for a particular user, such as User-A. The UE may represent any terminal in which the user may execute applications, such as a cellular or other mobile telephone, a PDA, notebook or laptop computer, or other similar device.

In the illustrated embodiment, the UE 800 includes a “check” mechanism that is initiated when the user initiates execution of the application. One example of such a check mechanism is the compare module 802, which may be implemented in software, hardware, or some combination thereof. The compare module 802 compares the application ID 804 associated with the application being executed, which may be presented upon initiation of application execution by the application execution module 806. The application execution module 806 may include a processing device controlled by software instructions, and upon initiation of the application, the application ID 804 for that application is made available to the compare module 802. A memory 807, which in one embodiment includes a SIM database, houses locally stored user profile information 808 and application IDs 810 to which the user is authorized to execute. The user profile information 808 may include information such as terminal data and user data such as telephone numbers, personal identification numbers (PINs), and the like. The application ID field 810 includes an identification of the applications known to be authorized at the UE 800.

If the compare module 802 determines that an application ID stored in the application ID field 810 of the memory 807 matches the application ID 804 corresponding to the executed application, an indication that a “match” has resulted is provided at output 812. Alternatively, if no match is found at the compare module 802, a “no-match” indication is output 812.

Depending on the state of the output 812, the user may immediately gain access to the application, or an additional check of the network database may be required. More particularly, if a match is found, the user of UE 800 is permitted to use the application. If no match is found, then correspondence between the application ID and the particular user must be found stored at the network, such as in a profile directory 820 that may be maintained on a network server.

To determine whether the user is allowed to execute the application, the profile directory 820 at the network includes information corresponding to individual users, shown in the user information field 822. For example, information may be provided for the user of terminal 800 (e.g., user-A), as illustrated by the user-A information 824. The profile directory 820 may also include the user information for other users of other terminals, such as user-B information 826 through user-n information 828. For example, the memory 807 includes a SIM DB having unique user profile information for user-A, who is using user-A equipment 800, where the user-A SIM DB information corresponds to the profile directory user-A information 824. Another user of the application, e.g., user-B, may use a different terminal (not shown) that includes a SIM DB of user-B's unique user profile information, which corresponds to the profile directory user-B information 826.

Each information block, such as user-A information 824, includes various stored information fields, including an application/services list 830 and application information 832. The application/services list 830 includes information about each application and service associated with user-A. This information allows the PD 820 to ensure proper charging of application use. The application information 832 includes information about all of the applications, including the application ID, the price to download the application, etc. This information is stored in the PD 820 to enable the correct payment requests and execution permission messages to the UE 800. The information between the UE 800 and the PD 820 are from time to time replicated therebetween, as illustrated by communication path 840.

Other mechanisms may be implemented in connection with the profile directory, such as the CDR creation module 850. The CDR creation module 850 creates a valid CDR (call data record) and delivers it to the charging gateway (CG) for the execution permission. Alternatives to use of the CDR creation module 850 may be implemented, such as having the PD 820 send the appropriate charging information to SGSN (Serving GPRS Support Node), which is a General Packet Radio Service Support (GPRS) support node that serves GPRS mobile by sending or receiving packets via a base station (BS) subsystem, and/or GGSN (Gateway GPRS Support Node), which is a GPRS support node that acts as a gateway between the GPRS network and external telephony and data networks.

Another mechanism is the unknown application handler 852 for treating unknown applications, such as carrying out predefined procedures to permit or restrict execution of unknown applications. Execution of this feature involves preliminary operations with the network. A subscriber account handler 854 handles situations where a subscriber has a prepaid account balance, and real-time reductions from the account are managed by the subscriber account handler 854. If the account balance is lower than the application price, the application execution may be immediately restricted.

Using the foregoing specification, the invention may be implemented as a machine, process, or article of manufacture by using standard programming and/or engineering techniques to produce programming software, firmware, hardware or any combination thereof.

Any resulting program(s), having computer-readable program code, may be embodied within one or more computer-usable media such as memory devices or transmitting devices, thereby making a computer program product or article of manufacture according to the invention. As such, the terms “article of manufacture” and “computer program product” as used herein are intended to encompass a computer program existent (permanently, temporarily, or transitorily) on any computer-usable medium such as on any memory device or in any transmitting device.

Executing program code directly from one medium, storing program code onto a medium, copying the code from one medium to another medium, transmitting the code using a transmitting device, or other equivalent acts, may involve the use of a memory or transmitting device which only embodies program code transitorily as a preliminary or final step in making, using, or selling the invention.

Memory devices include, but are not limited to, hard disk drives, diskettes, optical disks, magnetic tape, semiconductor memories such as RAM, ROM, PROMS, etc. Transmitting devices include, but are not limited to, the Internet, intranets, telephone/modem-based network communication, hard-wired/cabled communication network, cellular communication, radio wave communication, satellite communication, and other stationary or mobile network systems/communication links.

A machine embodying the invention may involve one or more processing systems including, but not limited to, CPU, memory/storage devices, communication links, communication/transmitting devices, servers, I/O devices, or any subcomponents or individual parts of one or more processing systems, including software, firmware, hardware, or any combination or subcombination thereof, which embody the invention as set forth in the claims.

From the description provided herein, those skilled in the art are readily able to combine software created as described with appropriate general purpose or special purpose computer hardware to create a computer system and/or computer subcomponents embodying the invention, and to create a computer system and/or computer subcomponents for carrying out the method of the invention.

It will, of course, be understood that various modifications and additions can be made to the various embodiments discussed hereinabove without departing from the scope or spirit of the present invention. Accordingly, the scope of the present invention should not be limited by the particular embodiments discussed above, but should be defined only by the claims set forth below and equivalents thereof.

What is claimed is:

1. A method for authorizing operation of an application on a terminal in a network, comprising:
initiating the application on the terminal of a requesting user;
searching a local user data segment for an application identifier of the initiated application, wherein the local user data segment is unique to a requesting user and locally available at the terminal;
searching for the application identifier on a remotely stored user data segment available on the network external to the terminal, if the application identifier is not located in the local user data segment; and
if the application identifier is located in the remotely stored user data segment, updating the local user data segment on the terminal with the application identifier, and enabling execution of the application by the requesting user.

2. The method as in claim 1, further comprising prohibiting execution of the application by the requesting user on the terminal where the application identifier is not located in the remotely stored user data segment.

3. The method as in claim 1, further comprising presenting the requesting user with an option to acquire the application, if the application identifier is not located in the remotely stored user data segment.

4. The method as in claim 3, further comprising accepting payment from the requesting user to acquire the application.

5. The method as in claim 4, further comprising updating the remotely stored user data segment to include the application identifier in response to accepting payment.

6. The method as in claim 4, further comprising updating the local user data segment to include the application identifier in response to accepting payment.

7. The method as in claim 4, further comprising enabling execution of the application by the requesting user in response to accepting payment.

8. The method as in claim 1, further comprising transmitting the application to the terminal, prior to initiating the application on the terminal.

9. The method as in claim 8, wherein transmitting the application to the terminal comprises transmitting the application from an authorized source of the application via the network.

10. The method as in claim 9, further comprising updating the remotely stored user data segment to include the application identifier, updating the local user data segment to include the application identifier, and enabling execution of the application by the requesting user, in response to the transmitting of the application from the authorized source of the application.

11. The method as in claim 8, wherein transmitting the application to the terminal comprises downloading the application onto the terminal from an unauthorized source of the application, wherein such transmission fails to cause updating of the remotely stored user data segment to include the application identifier, updating of the local user data segment to include the application identifier, and enabling execution of the application by the requesting user.

12. The method as in claim 1, wherein searching a local user data segment comprises searching a Subscriber Identity Module (SIM) database.

13. The method as in claim 12, wherein the SIM database is transferable to a plurality of different terminals.

14. The method as in claim 1, further comprising enabling execution of the application by the requesting user without searching the remotely stored user data segment stored on the network, if the application identifier is located in the local user data segment.

15. The method as in claim 1, wherein searching the remotely stored user data segment stored on the network for the presence of the application identifier comprises searching a profile directory stored on a server available on the network.

16. The method as in claim 1, further comprising synchronizing the local user data segment and the remotely stored user data segment at one or more predetermined occurrences such that at least the application identifier is replicated in both the local user data segment and the remotely stored user data segment.

17. The method as in claim 1, wherein searching the local user data segment comprises searching a portable storage module for the presence of an application identifier of the initiated application.

18. The method as in claim 17, wherein searching a portable storage module comprises searching a memory associated with a Subscriber Identity Module (SIM).

19. A method for charging for an application operable on a terminal within a network, where the application was not obtained from the application supplier where application charging generally occurs, comprising:
attempting to execute the application by a user on the terminal;
examining a locally stored user data segment for an application identifier of the application, and enabling execution of the application if the application identifier is found in the locally stored user data segment;
examining a remotely stored user data segment for the application identifier if the application identifier is not found in the locally stored user data segment, and enabling execution of the application if the application identifier is found in the remotely stored user data segment;
prohibiting the user from executing the application if the application identifier is not found in either the locally or remotely stored user data segment, and requiring payment for the application as a condition for thereafter enabling execution of the application.

20. The method as in claim 19, wherein examining a locally stored user data segment for an application identifier of the application comprises searching a portable access database unique to the user for the application identifier.

21. The method as in claim 19, further comprising periodically synchronizing the locally stored user data segment and the remotely stored user data segment.

22. A system for allowing a network service provider to control use of an application having an associated application identifier, comprising:
a transferable user data module including local user profile information unique to a user requesting access to the application;
a profile directory maintained on a network, wherein the profile directory includes remote user profile information for at least one user;
a user terminal having the application available therein, wherein the user terminal is coupled to the transferable user data module, the user terminal comprising:
(a) a compare module coupled to receive the application identifier of the application to determine whether the application identifier matches any authorized application identifiers associated with the local user profile information; and
(b) an application execution module to permit user execution of the application if the application identifier matches one of the authorized application identifiers associated with the local user profile information, and to request permission to execute the application from the service provider by searching the remote user profile information for the application identifier if the application identifier fails to match one of the authorized application identifiers associated with the local user profile information.

23. The system of claim 22, wherein the transferable user data module comprises a Subscriber Identity Module (SIM).

24. The system of claim 22, wherein the user terminal comprises a wireless terminal.

25. The system of claim 24, wherein the wireless terminal comprises a wireless telephone operable in a wireless network environment.

26. A method for enabling operation of an application on a terminal in a network, comprising:
linking an application identifier with user profile information unique to each user authorized to execute the application;
determining whether the application identifier has been linked with the user profile information of a requesting user attempting to execute the application from the terminal;
denying execution of the application to the requesting user if the application identifier has not been linked with the user profile information; and
enabling execution of the application to the requesting user if the application identifier has been linked with the user profile information.

27. The method of claim 26, wherein linking an application identifier with user profile information comprises storing the application identifier in a network profile directory segment remote to the terminal.

28. The method of claim 27, wherein determining whether the application identifier has been linked with the user profile information comprises searching a portion of the network profile directory uniquely corresponding to the requesting user for the application identifier.

29. The method of claim 28, wherein linking an application identifier with user profile information further comprising replicating the application identifier in a portable access module, if the application identifier is located in the network profile directory.

30. The method of claim 26, wherein linking an application identifier with user profile information comprises storing the application identifier in a portable access module.

31. The method of claim 30, wherein determining whether the application identifier has been linked with the user profile information comprises searching the portable access module for the application identifier.

32. A method for charging for an application operable on a terminal within a network, where the application was not obtained from the application supplier where application charging generally occurs, comprising:
attempting to execute the application by a user on the terminal;
examining a locally stored user data segment for an application identifier of the application, and enabling execution of the application if the application identifier is found in the locally stored user data segment;
examining a remotely stored user data segment for the application identifier if the application identifier is not found in the locally stored user data segment, and enabling execution of the application if the application identifier is found in the remotely stored user data segment; and
prohibiting the user from executing the application if the application identifier is not found in either the locally or remotely stored user data segment.

33. A method for authorizing execution of an application available on a terminal in a network, comprising:
storing an application identifier as at least a portion of a user data segment unique to each user authorized to execute the application, wherein the user data segments corresponding to each user are remotely stored on the network external to the terminal;
initiating the application on the terminal of a requesting user;
transmitting a request to the network to ascertain whether the requesting user is authorized to execute the application;
determining whether the application identifier is remotely stored in the requesting user's user data segment on the network, thereby determining whether the requesting user is authorized to execute the application;
prohibiting execution of the application to the requesting user if not authorized to execute the application; and
enabling execution of the application to the requesting user if authorized to execute the application.

34. The method as in claim 33, further comprising:
searching a locally stored user data segment for the application identifier upon initiating the application on the terminal of the requesting user; and
if the application identifier is stored in the locally stored user data segment, enabling execution of the application to the requesting user without requiring transmission of the request to the network and determining whether the application identifier is remotely stored on the network.

35. The method as in claim 33, further comprising providing the requesting user an option to pay for the application if the requesting user is not authorized to execute the application.

36. The method as in claim 35, further comprising enabling execution of the application to the requesting user upon providing payment for the application.

37. The method as in claim 33, further comprising:
searching a locally stored user data segment for the application identifier upon initiating the application on the terminal of the requesting user;
if the application identifier is stored in the locally stored user data segment, enabling execution of the application to the requesting user without requiring transmission of the request to the network and determining whether the application identifier is remotely stored on the network;
if the application identifier is not stored in the locally stored user data segment, providing the requesting user an option to pay for the application if the requesting user is not authorized to execute the application;
enabling execution of the application to the requesting user upon providing payment for the application; and
updating the locally stored user data segment with the application identifier.

38. A computer-readable medium having computer-executable instructions for authorizing execution of an application operable on a terminal within a network, the computer-executable instructions performing steps comprising:
attempting to execute the application by a user on the terminal;
examining a locally stored user data segment for an application identifier of the application, and enabling execution of the application if the application identifier is found in the locally stored user data segment;
examining a remotely stored user data segment for the application identifier if the application identifier is not found in the locally stored user data segment, and enabling execution of the application if the application identifier is found in the remotely stored user data segment; and
prohibiting the user from executing the application if the application identifier is not found in either the locally or remotely stored user data segment.

39. A system for enabling operation of an application on a terminal in a network, comprising:
means for linking an application identifier with user profile information unique to each user authorized to execute the application;
means for determining whether the application identifier has been linked with the user profile information of a requesting user attempting to execute the application from the terminal;
means for denying execution of the application to the requesting user if the application identifier has not been linked with the user profile information; and
means for enabling execution of the application to the requesting user if the application identifier has been linked with the user profile information.
